(19) United States
(12) Patent Application Publication
(10) Pub. No.: US 2007/0216843 A1
(43) Pub. Date: Sep. 20, 2007

(54) Liquid crystal display and backlight controlling method

(75) Inventor: Ming-Hung Tsai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/725,722

(22) Filed: Mar. 19, 2007

(30) Foreign Application Priority Data
Mar. 17, 2006 (TW) 95109287

(51) Int. Cl. G02F 1/1343

(52) U.S. Cl. 349/143

(57) ABSTRACT

An exemplary liquid crystal display (LCD) (100) includes a liquid crystal panel (12) comprising a plurality of scanning lines; a light guide plate (10) under the liquid crystal panel; and a light source (13) adjacent to a side of the light guide plate. The light source has a plurality of light emitting diodes, which turn on or turn off according to the different system displaying mode.

### FIELD OF THE INVENTION

The present invention relates to a liquid crystal display (LCD) and a backlight controlling method of the LCD for adjusting a luminance of a display screen of the active matrix LCD.

### GENERAL BACKGROUND

A liquid crystal display (LCD) is one kind of display system that cannot produce illumination for a displayed image by itself. Therefore in order to display images, a planar light source (e.g. a backlight unit) is usually provided with an LCD panel. The backlight unit is configured with the LCD panel so as to provide a bright and uniform planar light source. Two types of backlight unit (i.e. side edge type and direct type) are well-known in this field.

Backlight unit of side edge type is illustrated below. The side edge type backlight is always in bright state and mounted aside to the light guide plate for the LCD module so as to transmit light beam to LCD panel. The LCD panel usually includes a so-called upper substrate and a lower substrate. The pixel electrode (at the lower substrate) and the common electrode (at the upper substrate) cooperatively constitute a capacitor. During display images, each scan signal coming from the corresponding gate electrode is proceeded a scan process upon each column of pixels sequentially. At the moment of changing different scanning columns, light beam cannot be exactly controlled due to the capacitor's effect according to the scanning signals applied to the corresponding pixels in a predetermined manner that the contrast of display images is decreased. Furthermore, due to mutually reinforcing of lower response time for liquid crystal molecules and the persistence of vision in human eyes, the blurred image of object movement of image display and the contrast in boundary shape of the displaying object became worse are occurred.

In the other case, a typical direct type backlight unit is described as follows. Several cold cathode fluorescent lamps (CCFLs) are set under the light guide plate of the LCD module. In order to overcome the weakness of side edge type backlight, the timing signals from timing controller are used to turn on or turn off the foregoing CCFLs so as to control the light beams introduced to the LCD panel in accordance with the timing signals.

However, the LCD 100 can not automatically adjust the brightness when the ambient brightness is changed. Thus a user may find that his or her eyes easily become tired.

What is needed, therefore, is an LCD that can overcome the above-described deficiency.

### SUMMARY

In one preferred embodiment, An exemplary liquid crystal display (LCD) includes a liquid crystal panel comprising a plurality of scanning lines; a light guide plate under the liquid crystal panel; and a light source adjacent to a side of the light guide plate. The light source has a plurality of light emitting diodes, which turn on or turn off according to the different system displaying mode.

A backlight controlling method for a liquid crystal display (LCD), includes providing a liquid crystal panel which has a data driving circuit and a gate driving circuit, and a plurality of scanning lines; providing a light source illuminating the liquid crystal panel and a backlight controlling circuit connecting the light source; and providing a timing controlling circuit, respectively connecting the data driving circuit and the gate driving circuit, and the backlight controlling circuit. The timing controlling circuit controls the data driving circuit and the gate driving circuit, and the backlight controlling circuit according received video signals and system displaying mode signals.

Other advantages and novel features will become more apparent from the following detailed description when taken in conjunction with the accompanying drawings.

### BRIEF DESCRIPTION OF THE DRAWINGS

FIG. 1 is a schematic, isometric view of a liquid crystal display according to a first embodiment of the present invention.

FIG. 2 is an abbreviated block diagram of a backlight controlling circuit of the LCD of FIG. 1, the LCD including a timing control circuit.

FIG. 2 is an abbreviated block diagram of a brightness controlling circuit of the active matrix LCD of FIG. 1.

FIG. 3 and FIG. 4 are schematic views showing a first controlling method of the LCD of FIG. 1.

FIG. 5 is a schematic view showing a second controlling method of the LCD of FIG. 1.

FIG. 6 is a schematic view showing a third controlling method of the LCD of FIG. 1.

FIG. 7 is a schematic view showing a fourth controlling method of the LCD of FIG. 1.

FIG. 8 is a schematic view showing a fifth controlling method of the LCD of FIG. 1.

### DETAILED DESCRIPTION OF PREFERRED EMBODIMENTS

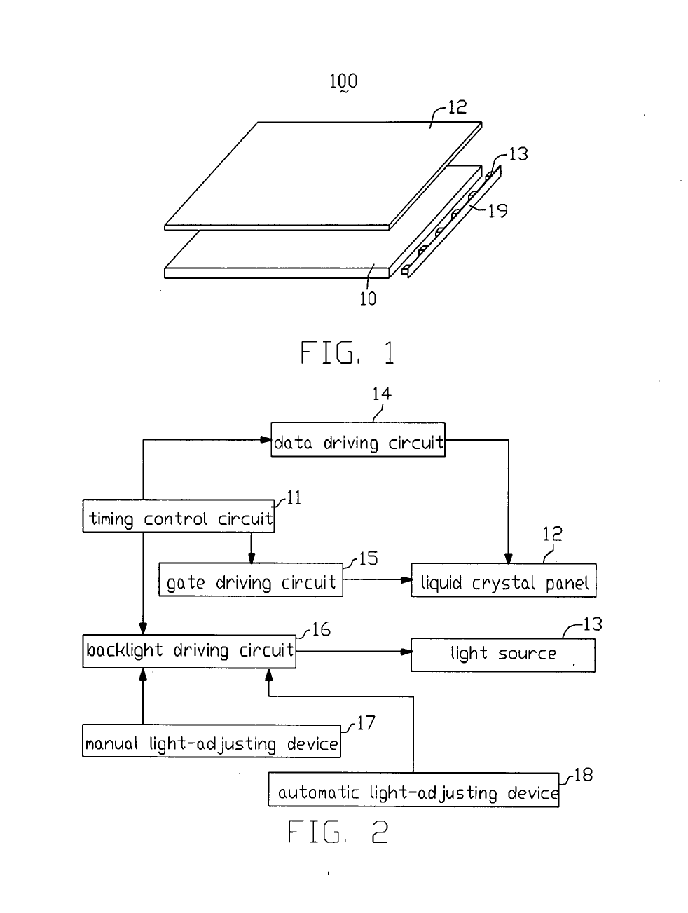

FIG. 1 is a schematic, isometric view of a liquid crystal display according to a first embodiment of the present invention. The LCD 100 includes a liquid crystal (LC) panel 12, a light guide plate 10 under the LC panel 12, a light source 13 disposed at one side of the light guide plate 10. The LCD 100 is configured such that an image shown on a display screen (not shown) of the LC panel 12 is refreshed. The LC panel 12 has a plurality of scanning lines (not shown), which is perpendicular to the side of the light guide plate 10 adjacent to the light source 13. The light source 13 has a plurality of light emitting diodes (LEDs) attached on a printed circuit board (PCB) 19. Each LED provides luminance corresponding to a region controlled by a plurality of scanning lines at the LC panel 12.

As shown in FIG. 2, the LCD 100 also includes a timing control circuit 11, a gate driving circuit 15 connecting with the timing control circuit 11, a data driving circuit 14 connecting with the timing control circuit 11, a backlight driving circuit 16 connecting with the timing control circuit 11 and controlling the light source 13 to illuminate. The gate driving circuit 15 and the data driving circuit 14 electrically connect to the LC panel 12 for providing signals to the LC panel 12. The LCD 100 further provides a manual light-adjusting device 17 and an automatic light-adjusting device 18, which respectively connect to the backlight driving circuit 16.

The timing control circuit 11 synchronously controls the gate driving circuit 15, the data driving circuit 14 and the backlight driving circuit 16. When the timing control circuit 11 receives a video signal and a system displaying mode signal, the timing control circuit 11 sends a synchronous controlling signal to the gate driving circuit 15, the data driving circuit 14 and the backlight driving circuit 16. The backlight driving circuit 16 controls on/off state of the light source 13 according to the control signals, for providing luminance of the LC panel 12. The gate driving circuit 15 and the data driving circuit 14 control the LC panel to display images according the video signal and the synchronous controlling signal. In addition, the automatic light-adjusting device 18 can automatically adjust the luminance of the light source 13 according to a luminance signal of environment from a light sensor. Moreover, user can further adjust the luminance of the light source 13 according to his special needs.

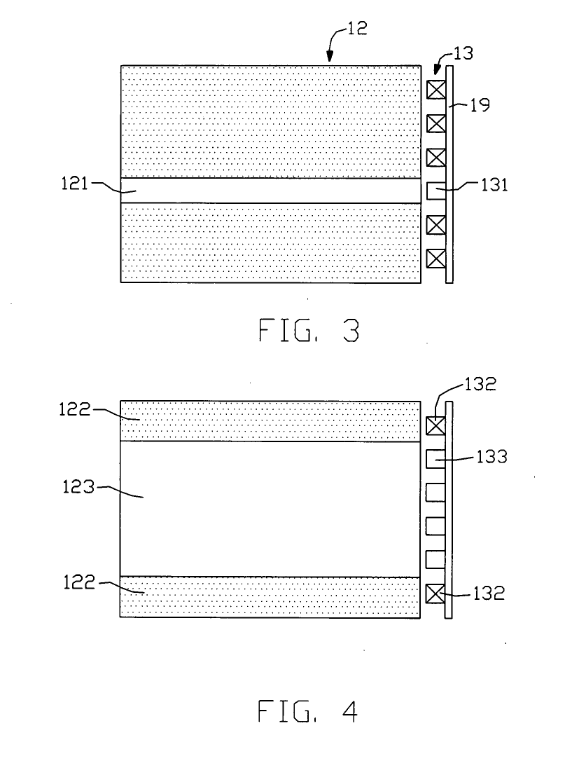

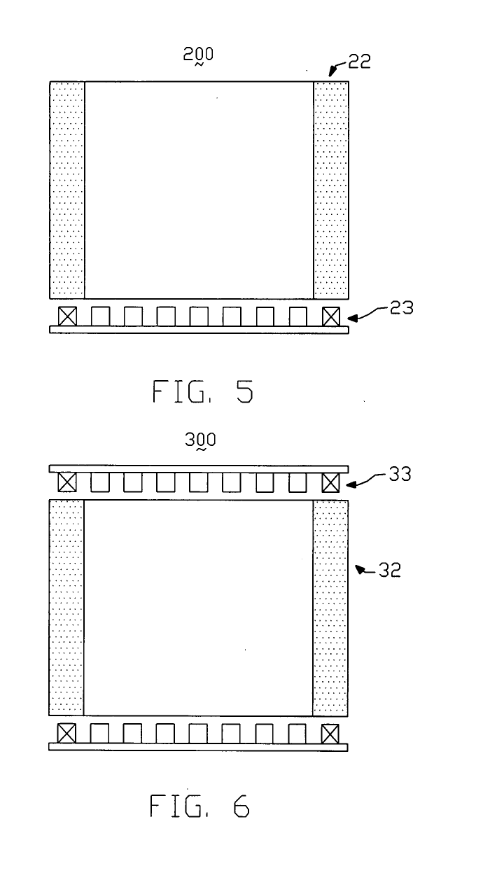

Referring to FIG. 3, the LCD 100 works in a whole screen mode. The timing control circuit 11 sends a synchronous controlling signal to the gate driving circuit 15, the data driving circuit 14 and the backlight driving circuit 16, according to the received video signal and a system displaying mode signal. The backlight driving circuit 16 accordingly turns on or turns off the light source 13.

For example, an LED 131 accords to a displaying region 121, which corresponds to the plurality of scanning lines numbered N to N+M. When the scanning line numbered N scans, the LED 131 turns on; and when the scanning line numbered N+M finishes scanning, the LED 131 turns off. And next LED follows the controlling method until a frame image displaying finishes. Thus, in a frame image displaying, each LED turns at least one time.

The LCD 100 utilizes the light source 13 having a plurality of LEDs and the timing control circuit 11 synchronously controlling the gate driving circuit 15 and the backlight driving circuit 16 to realize the backlight driving circuit 16 respectively controlling the plurality of LEDs of the light source 13. Thus, the plurality of LEDs does not keep a turn-on state at all times. Therefore, the LCD 100 has a low energy consumption. In addition, the LCD 100 having a small size can also attain a backlight scanning efficiency generally used in a large size LC panel. Thus, the LCD 100 can lower the sticking image. In addition, for improving the luminance of the LC panel 12, the LCD 100 can further has two light sources 13 opposite to each other.

In modification, time of each LCD turning on can be longer than scanning time of accordingly scanning lines. The light source 13 also can be bonded on a flexible printed circuit (FPC). The LED can be a white LED.

Referring to FIG. 4, the LCD 100 works at a letterbos mode. The LEDs 132 corresponding to a black region 122 at the LC panel 12 turns off. The LEDs 133 corresponding to an image displaying region 123 at the LC panel 12 turn on, which utilize the timing control circuit 11 synchronously controlling the gate driving circuit 15 and the backlight driving circuit 16.

Referring to FIG. 5, an LCD 200 according to a second embodiment of the present invention is shown. The LCD 200 includes a liquid crystal (LC) panel 22, a light guide plate (not shown) under the LC panel 22, a light source 23 disposed at one side of the light guide plate. The LCD 200 is configured such that an image shown on a display screen (not shown) of the LC panel 22 is refreshed. The LC panel 22 has a plurality of scanning lines (not shown), which is parallel to the side of the light guide plate 20 adjacent to the light source 23.

Referring to FIG. 6, an LCD 300 according to a third embodiment of the present invention is shown. The LCD 300 has a similar structure to the LCD 200 except that the LCD 300 has two light sources 33, respectively disposed at two opposite sides of a light guide plate. The two opposite sides are parallel to scanning lines of the LC panel 32.

The two LCDs 200, 300 according to the second and the third embodiments can work in a pillarbox mode.

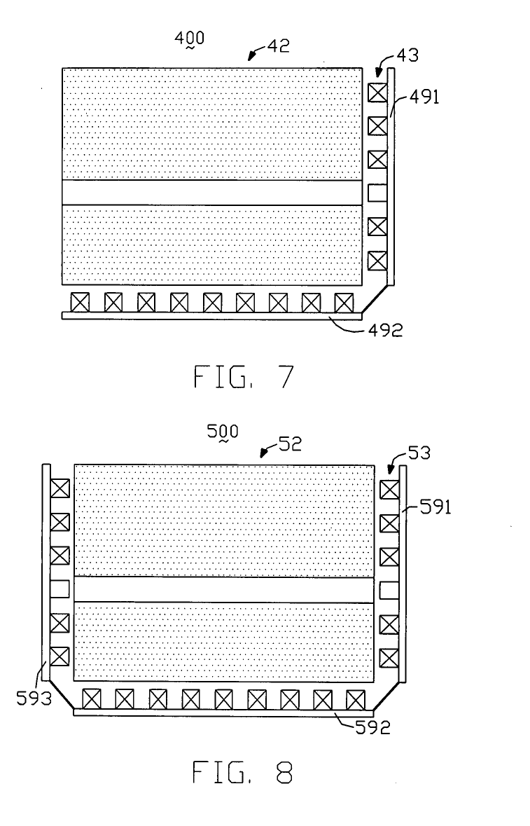

Referring to FIG. 7, an LCD 400 according to a fourth embodiment of the present invention is shown. The LCD 400 has a similar structure to the LCD 100 except that the LCD 400 has two light sources 43, respectively disposed adjacent to two adjacent sides of a light guide plate. The two opposite sides are perpendicular to scanning lines of the LC panel 42. Two PCBs 491, 492 for bearing the two light sources 43 electrically connect each other through wires or FPC.

Referring to FIG. 8, an LCD 500 according to a fifth embodiment of the present invention is shown. The LCD 500 has a similar structure to the LCD 100 except that the LCD 500 has three light sources 53, respectively disposed adjacent to three adjacent sides of a light guide plate. Three PCBs 591, 592, 593 for respectively bearing the three light sources 53 electrically connect each other through wires or FPC.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display (LCD), comprising:
a liquid crystal panel comprising a plurality of scanning lines;
a light guide plate under the liquid crystal panel; and
a light source adjacent to a side of the light guide plate;
wherein the light source has a plurality of light emitting diodes, which turn on or turn off according to the different system displaying mode.

2. The LCD as claimed in claim 1, wherein the plurality of light emitting diodes is disposed adjacent to the side of the light guide plate.

3. The LCD as claimed in claim 2, wherein the side of the light guide plate is perpendicular to the plurality of scanning lines.

4. The LCD as claimed in claim 2, wherein the side of the light guide plate is parallel to the plurality of scanning lines.

5. The LCD as claimed in claim 1, wherein the plurality of light emitting diodes is disposed adjacent to two adjacent sides of the light guide plate.

6. The LCD as claimed in claim 1, wherein the plurality of light emitting diodes is disposed adjacent to two opposite sides of the light guide plate.

7. The LCD as claimed in claim 6, wherein the two sides of the light guide plate are perpendicular to the plurality of scanning lines.

8. The LCD as claimed in claim 6, wherein the two sides of the light guide plate are parallel to the plurality of scanning lines.

9. The LCD as claimed in claim 1, wherein the plurality of light emitting diodes is disposed adjacent to three adjacent sides of the light guide plate.

10. The LCD as claimed in claim 1, wherein the LED is a white LED.

11. A backlight controlling method for a liquid crystal display (LCD), comprises:
providing a liquid crystal panel which has a data driving circuit and a gate driving circuit, and a plurality of scanning lines;
providing a light source illuminating the liquid crystal panel and a backlight controlling circuit connecting the light source; and
providing a timing controlling circuit, respectively connecting the data driving circuit and the gate driving circuit, and the backlight controlling circuit;
wherein the timing controlling circuit controls the data driving circuit and the gate driving circuit, and the backlight controlling circuit according received video signals and system displaying mode signals.

12. The method as claimed in claim 12, wherein the light source has a plurality of LEDs, each LED corresponding to the plurality of scanning lines numbered N to N+M, the LED turns on when the scanning line numbered N scans, and the LED turns off when the scanning line numbered N+M finishes scanning, when the LCD works in a whole screen mode.

13. The method as claimed in claim 13, wherein each LED turns at least one time, in a frame image displaying.

14. The method as claimed in claim 13, wherein the LEDs corresponding to a black region at an LC panel of the LCD turns off when the LCD 100 works at a letterbos mode.

15. The method as claimed in claim 15, wherein the LEDs corresponding to a display image region at the LC panel turns on when the LCD 100 works at a letterbos mode.

16. The method as claimed in claim 13, wherein the LEDs corresponding to a black region at an LC panel of the LCD turns off, and the LEDs corresponding to a display image region at the LC panel turns on, when the LCD 100 works at a pillarbox mode.

17. The method as claimed in claim 13, wherein the LCD further provides an automatic light-adjusting device, which can automatically adjust the luminance of the light source according to a luminance signal of environment from a light sensor.

18. The method as claimed in claim 13, wherein the LCD further provides annual light-adjusting device, by which user can further adjust the luminance of the light source according to his special needs.

19. A liquid crystal display (LCD), comprising:
a liquid crystal panel defining a plurality of scanning lines;
a light guide plate under the liquid crystal panel; and
a light source adjacent to a side of the light guide plate;
wherein the light source turns on and off according to a neighboring region formed by the scanning lines adjacent thereto.
